(19) United States
(12) Patent Application Publication
(10) Pub. No.: US 2026/0211437 A1
(43) Pub. Date: Jul. 23, 2026

(54) LOW QUIESCENT POWER LOW DROPOUT TOPOLOGY

(71) Applicant: QUALCOMM Incorporated, San Diego, CA (US)

(72) Inventor: Kshitij YADAV, San Diego, CA (US)

(21) Appl. No.: 19/035,004

(22) Filed: Jan. 23, 2025

(51) Int. Cl. G05F 1/575; G05F 1/59

(52) U.S. Cl. CPC G05F 1/575; G05F 1/59

(57) ABSTRACT

A voltage regulator includes a voltage circuit configured to generate a gate voltage based on a reference voltage. The voltage regulator also includes an n-type field effect transistor (NFET), wherein a gate of the NFET is coupled to the voltage circuit to receive the gate voltage, and a source of the NFET is coupled to an output of the voltage regulator. The voltage regulator also includes a current source coupled between a supply rail and a drain of the NFET, and a p-type field effect transistor (PFET), wherein a source of the PFET is coupled to the supply rail, a gate of the PFET is coupled to the drain of the NFET, and a drain of the PFET is coupled to the output of the voltage regulator.

### BACKGROUND

### Field

Aspects of the present disclosure relate generally to voltage regulation, and more particularly, to voltage regulators.

### Background

Voltage regulators are used in a variety of systems to provide regulated voltages to power circuits (e.g., digital circuits) in the systems. A commonly used voltage regulator is a low-dropout (LDO) regulator. An LDO regulator typically includes a transistor and an amplifier coupled in a feedback loop to provide a regulated voltage based on a reference voltage.

### SUMMARY

The following presents a simplified summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

A first aspect relates to a voltage regulator. The voltage regulator includes a voltage circuit configured to generate a gate voltage based on a reference voltage. The voltage regulator also includes an n-type field effect transistor (NFET), wherein a gate of the NFET is coupled to the voltage circuit to receive the gate voltage, and a source of the NFET is coupled to an output of the voltage regulator. The voltage regulator also includes a current source coupled between a supply rail and a drain of the NFET, and a p-type field effect transistor (PFET), wherein a source of the PFET is coupled to the supply rail, a gate of the PFET is coupled to the drain of the NFET, and a drain of the PFET is coupled to the output of the voltage regulator.

A second aspect relates to a voltage regulator. The voltage regulator includes a first n-type field effect transistor (NFET), wherein a drain of the first NFET is coupled to a supply rail, a first resistor coupled between a source of the first NFET and a low rail, and an amplifier, wherein a first input of the amplifier is configured to receive a reference voltage, a second input of the amplifier is coupled to the source of the first NFET via a feedback path, and an output of the amplifier is coupled to a gate of the first NFET. The voltage regulator also includes a second NFET, wherein a gate of the second NFET is coupled to the gate of the first NFET, and a source of the second NFET is coupled to an output of the voltage regulator. The voltage regulator also includes a current source coupled between the supply rail and a drain of the second NFET, and a p-type field effect transistor (PFET), wherein a source of the PFET is coupled to the supply rail, a gate of the PFET is coupled to the drain of the second NFET, and a drain of the PFET is coupled to the output of the voltage regulator.

A third aspect relates to a method for operating a voltage regulator. The voltage regulator includes an n-type field effect transistor (NFET) and a p-type field effect transistor (PFET), wherein a source of the NFET is coupled to an output of the voltage regulator, a source of the PFET is coupled to a supply rail, a gate of the PFET is coupled to a drain of the NFET, and a drain of the PFET is coupled to the output of the voltage regulator. The method includes generating a gate voltage based on a reference voltage, applying the gate voltage to a gate of the NFET, and providing a bias current to the drain of the NFET.

### BRIEF DESCRIPTION OF THE DRAWINGS

FIG. 1 shows an example of a low-dropout (LDO) regulator according to certain aspects of the present disclosure.

FIG. 2 shows an example in which a load current of a circuit coupled to the LDO regulator is modeled by a current source according to certain aspects of the present disclosure.

FIG. 3 is a plot illustrating an example of the loop gain of the LDO regulator versus frequency for different load currents according to certain aspects of the present disclosure.

FIG. 4 shows an example of a voltage regulator including a first loop for setting an output voltage of the voltage regulator and a second loop for handling large load currents according to certain aspects of the present disclosure.

FIG. 5 shows an example in which a load current of a circuit coupled to the voltage regulator of FIG. 4 is modeled by a current source according to certain aspects of the present disclosure.

FIG. 6 is a plot illustrating an example of a gate voltage and a current of a p-type field effect transistor (PFET) versus load current according to certain aspects of the present disclosure.

FIG. 7 is a timing diagram illustrating an example of a load current, an output voltage, and a gate voltage of a PFET according to certain aspects of the present disclosure.

FIG. 8 is a flowchart illustrating a method for operating a voltage regulator according to certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

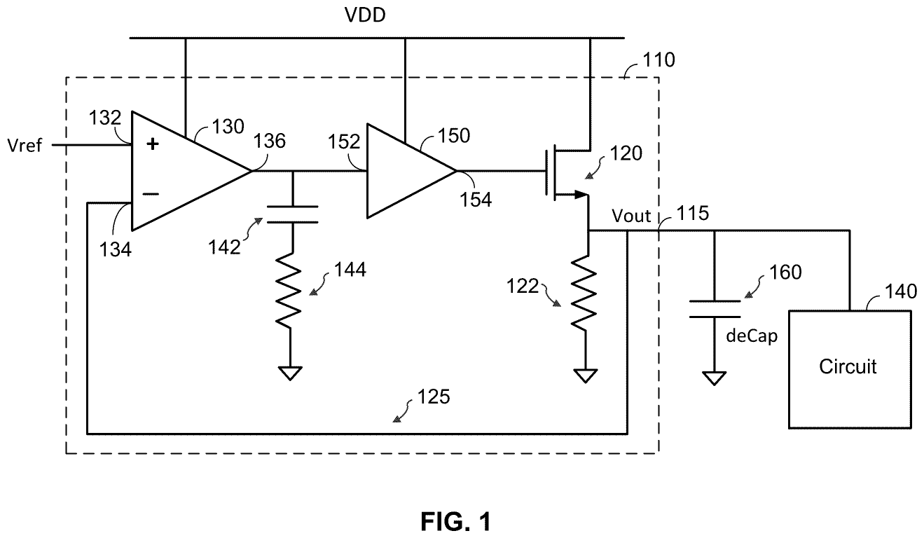

FIG. 1 shows an example of a low-dropout (LDO) regulator 110 according to certain aspects of the present disclosure. The output 115 of the LDO regulator 110 is coupled to a circuit 140 (e.g., a digital circuit) to provide the circuit 140 with a regulated output voltage Vout from a supply rail having a supply voltage VDD. The output 115 of the LDO regulator 110 may also be coupled to a decoupling capacitor 160 (e.g., to reduce noise on Vout).

In this example, the LDO regulator 110 includes a transistor 120, an amplifier 130, a buffer 150, and a resistor 122. The transistor 120 is coupled between the supply rail and the output 115 of the LDO regulator 110. In the example shown in FIG. 1, the transistor 120 is implemented with an n-type field effect transistor (NFET) in which the drain of the transistor 120 is coupled to the supply rail and the source of the transistor 120 is coupled to the output 115 of the LDO regulator 110. The resistor 122 is coupled between the source of the transistor 120 and a low rail (e.g., ground rail). As used herein, a low rail is a rail having a lower potential (e.g., ground potential) than the supply rail.

The amplifier 130 has a first input 132, a second input 134, and an output 136. The first input 132 (e.g., plus input) of the amplifier 130 is configured to receive a reference voltage Vref. The reference voltage Vref may come from a bandgap circuit (not shown) or another stable voltage source. The second input 134 (e.g., minus input) of the amplifier 130 is coupled to the output 115 of the LDO regulator 110 via a feedback path 125.

The buffer 150 has an input 152 and an output 154 in which the input 152 is coupled to the output 136 of the amplifier 130 and the output 154 is coupled to the gate of the transistor 120. In this example, the buffer 150 drives the gate of the transistor 120 based on the voltage at the output 136 of the amplifier 130. The buffer 150 may include a source follower, a unity-gain amplifier, and/or another type of voltage buffer.

In the example in FIG. 1, the LDO regulator 110 also includes a resistor 144 and a capacitor 142 coupled in series between the output 136 of the amplifier 130 and the low rail. As discussed further below, the resistor 144 and the capacitor 142 introduce a zero in the control loop of the LDO regulator 110 that helps with stability.

During operation, the LDO regulator 110 regulates the voltage at the output 115 based on the reference voltage Vref. More particularly, the amplifier 130 receives the reference voltage Vref at the first input 132 and the regulated output voltage Vout is fed back to the second input 134 via the feedback path 125. The amplifier 130 outputs a voltage at the output 136 based on the difference between the reference voltage Vref and the regulated output voltage Vout. The output voltage of the amplifier 130 causes the buffer 150 to drive the gate of the transistor 120 in a direction that reduces the difference between the reference voltage Vref and the regulated output voltage Vout. This forces the output voltage Vout of the LDO regulator 110 to be approximately equal to the reference voltage Vref.

For example, if the output voltage Vout decreases (e.g., due to a transient load current), the difference between the reference voltage Vref and the output voltage Vout increases. In response, the amplifier 130 adjusts the output voltage of the amplifier 130 in a direction that causes the buffer 150 to increase the gate voltage of the transistor 120. The increased gate voltage causes the conductance of the transistor 120 to increase, which lowers the current-resistor (IR) drop across the transistor 120. The lower IR drop across the transistor 120 pulls up the output voltage Vout, which reduces the difference between the reference voltage Vref and the output voltage Vout in this case. This example assumes that the transistor 120 is implemented with the NFET. However, it is to be appreciated that the present disclosure is not limited to this example.

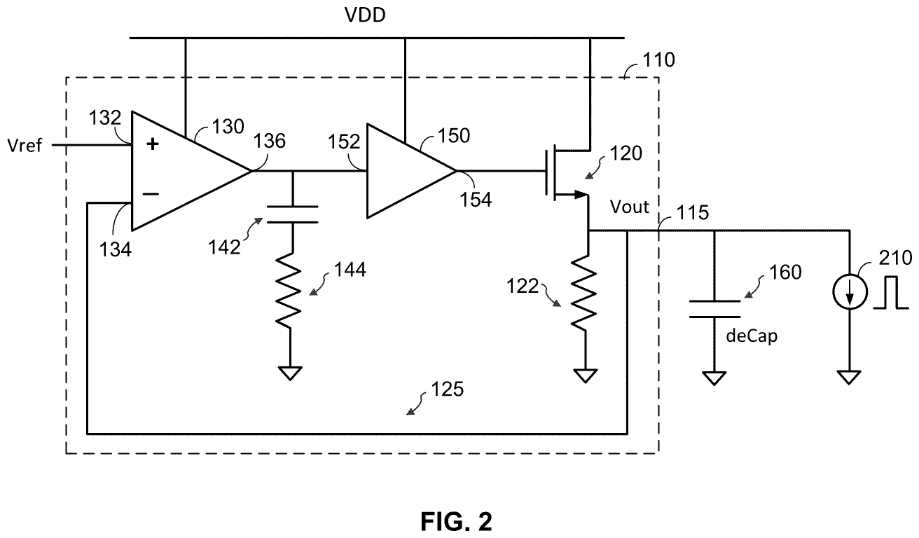

As discussed above, the circuit 140 may be a digital circuit. In this example, the circuit 140 may produce large transient load currents due to high-speed switching of transistors in the circuit 140. In this regard, FIG. 2 shows an example in which the transient load currents drawn by the circuit 140 are modeled by a current source 210 with current pulses representing the transient load currents.

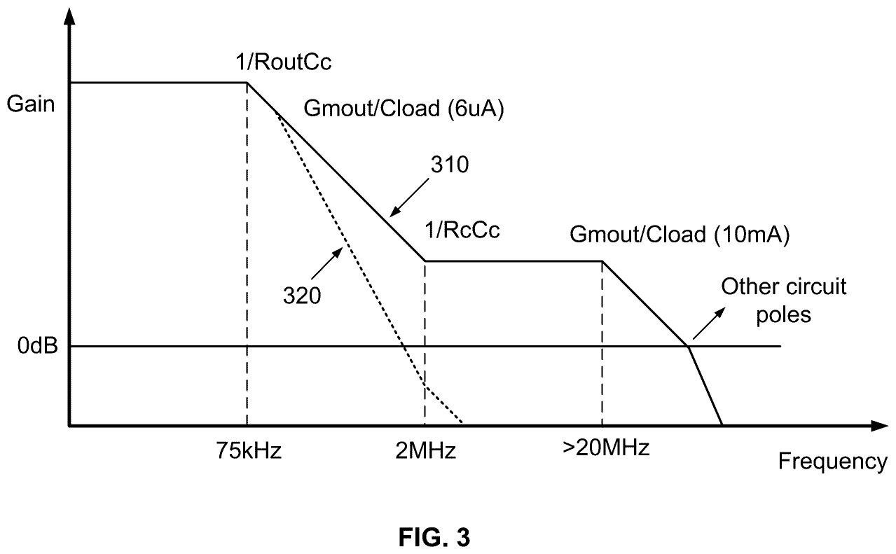

In this example, the transient load currents from the circuit 140 can cause the load current at the output 115 of the LDO regulator 110 to change by orders of magnitude, which can result in stability issues for the LDO regulator 110. This may be explained with reference to FIG. 3, which is a plot showing an example of the loop gain of the LDO regulator 110 versus frequency. In this example, the LDO regulator 110 has a first pole located at approximately 1/RoutCc where Rout is the output resistance of the amplifier 130 and Cc is the capacitance of the capacitor 142. The LDO regulator 110 also has a second pole located at Gmout/Cload where Gmout is the transconductance of the LDO regulator 110 and Cload is the load capacitance at the output 115 of the LDO regulator 110. The LDO regulator 110 also has a zero located at 1/RcCc where Rc is the resistance of the resistor 144 and Cc is the capacitance of the capacitor 142. As discussed above, the resistor 144 and the capacitor 142 are added to the LDO regulator 110 with help with stability.

Gmout/Cload is highly dependent on the load current at the output 115 of the LDO regulator 110, which causes the location of the second pole to change with changes in the load current. In this regard, FIG. 3 shows an example of the location of the second pole for a load current of 10 mA and the location of the second pole for a load current of 6 uA. The high current of 10 mA may be due to a transient load current from the circuit 140 and the low current of 6 uA may occur between transient load currents. In FIG. 3, the loop gain 310 for the load current of 10 mA is shown in solid line and the loop gain 320 for the load current of 6 uA is shown in dotted line.

As shown in FIG. 3, for the low load current of 6 uA, the second pole is located close to the first pole and to the left of the zero. This reduces the phase margin of the control loop and may lead to instability at low load current conditions. To address this, the quiescent current of the LDO regulator 110 may be increased by increasing the current flowing through the resistor 122 in the LDO regulator 110. The higher quiescent current moves the location of the second pole to higher frequency at low load current conditions, which improves stability. However, the higher quiescent current increases the power consumption of the LDO regulator 110.

To address the above, aspects of the present disclose provides a voltage regulator with two separate loops including a first loop for setting the regulated output voltage and a high-speed second loop for handling large transient load currents. As discussed further below, aspects of the present disclosure allow the voltage regulator to achieve low quiescent power consumption across a wide range of load currents (e.g., from several uAs to several mAs).

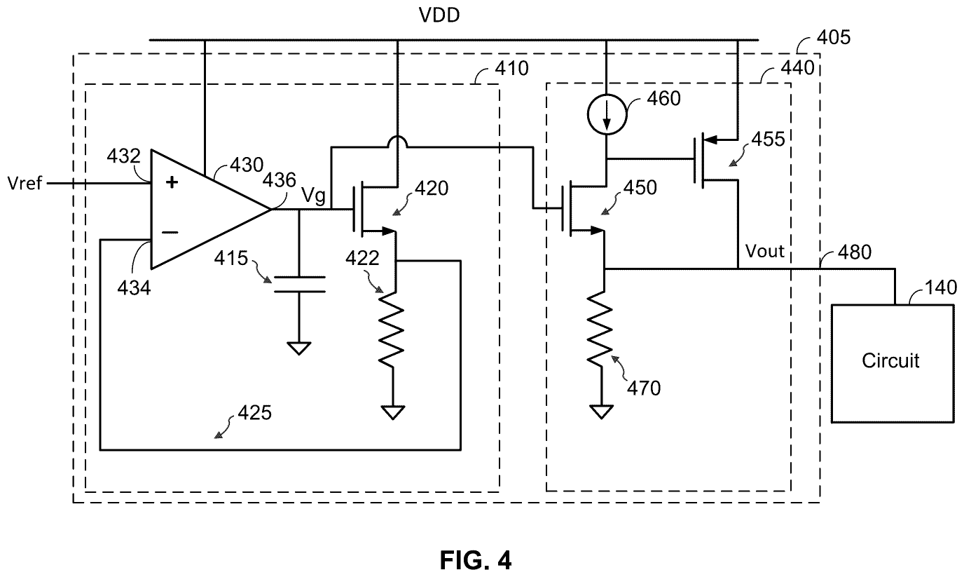

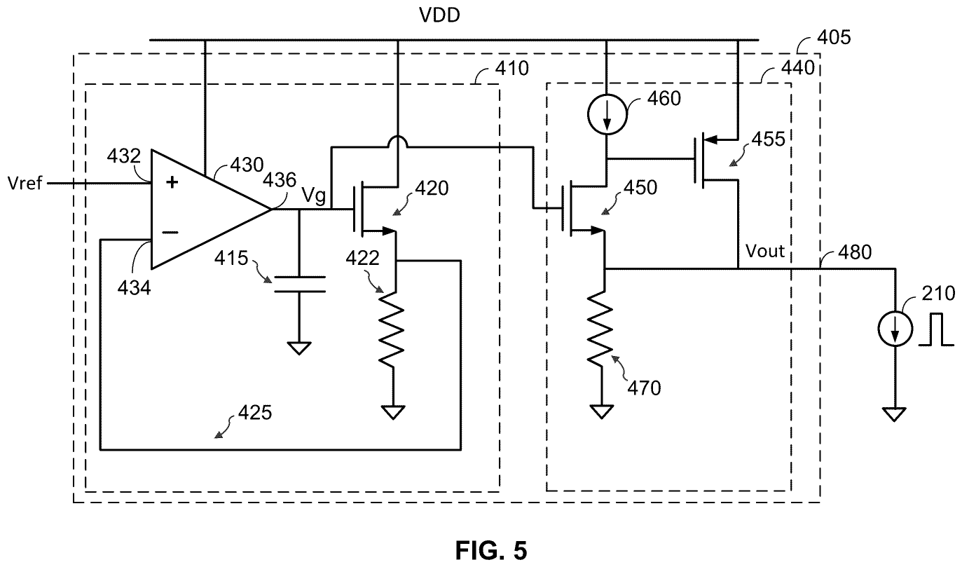

FIG. 4 shows an example of a voltage regulator 405 according to certain aspects of the present disclosure. The voltage regulator 405 includes a voltage circuit 410 and a current circuit 440. The voltage regulator 405 provides a regulated output voltage Vout at the output 480, which may be coupled to the circuit 140. The output 480 may also be coupled to the decoupling capacitor 160 (shown in FIGS. 1 and 2). FIG. 5 shows the example in which transient load currents drawn by the circuit 140 are modeled by the current source 210 with current pulses representing the transient load currents.

In the example in FIG. 4, the voltage circuit 410 includes a transistor 420, a resistor 422, and an amplifier 430. The transistor 420 is coupled between the supply rail and the resistor 422 and the resistor 422 is coupled between the transistor 420 and the low rail (e.g., ground rail). In the example shown in FIG. 4, the transistor 420 is implemented with an NFET in which the drain of the transistor 420 is coupled to the supply rail and the resistor 422 is coupled between the source of the transistor 420 and the low rail (e.g., ground rail).

The amplifier 430 has a first input 432, a second input 434, and an output 436. The first input 432 (e.g., plus input) of the amplifier 430 is configured to receive the reference voltage Vref, which may come from a bandgap circuit (not shown) or another stable voltage source. The second input 434 (e.g., minus input) of the amplifier 430 is coupled to the source of the transistor 420 via a feedback path 425. As a result, the voltage at the source of the transistor 420 is fed back to the second input 434 of the amplifier 430. The voltage circuit 410 may also include a capacitor 415 coupled between the output 436 of the amplifier 430 and the low rail.

In this example, the transistor 420 and the amplifier 430 are coupled in a first loop that causes the amplifier 430 to adjust the gate voltage Vg of the transistor 420 in a direction that reduces the difference between the reference voltage Vref and the voltage at the source of the transistor 420. This forces the voltage at the source of the transistor 420 to be approximately equal to the reference voltage Vref. Thus, in this example, the first loop sets the gate voltage Vg of the transistor 420 such that the source voltage of the transistor 420 is approximately equal to the reference voltage Vref. The gate voltage Vg is provided to the current circuit 440 for setting the output voltage Vout of the voltage regulator 405, as discussed further below.

In this example, the transistor 420 in the first loop is not used for handling load currents, unlike the transistor 120 in FIGS. 1 and 2. As a result, the first loop is not subject to the stability issues discussed above caused by varying load current conditions. This allows the current flowing through the transistor 420 to be low for low power consumption without negatively impacting stability at low load current conditions.

The current circuit 440 includes an NFET 450, a current source 460, a p-type field effect transistor (PFET) 455, and a resistor 470. The gate of the NFET 450 is coupled to the gate of the transistor 420. As a result, the gate voltage Vg set by the first loop is applied to the gate of the NFET 450. The current source 460 is coupled between the supply rail and the NFET 450. The current source 460 is configured to provide a bias current for the NFET 450. The resistor 470 is coupled between the NFET 450 and the low rail (e.g., ground rail). In the example shown in FIG. 4, the current source 460 is coupled between the supply rail and the drain of the NFET 450 and the resistor 470 is coupled between the source of the NFET 450 and the low rail (e.g., ground rail). The resistor 470 may be sized to provide an appropriate quiescent bias current to the NFET 450. In certain aspects, the NFET 450 may be significantly larger than the transistor 420 to increase the load current drivability of the voltage regulator 405. For example, the channel width of the NFET 450 may be at least twice the channel width of the transistor 420. In one example, the channel width of the NFET 450 may be approximately eight times the channel width of the transistor 420. For the example where the transistor 420 is implemented with an NFET, the transistor 420 may be referred to as the first NFET and the NFET 450 may be referred to as the second NFET, or vice versa.

In the example in FIG. 4, the output 480 of the voltage regulator 405 is coupled to the source of the NFET 450. Thus, in this example, the output voltage Vout of the voltage regulator 405 is provided by the voltage at the source of the NFET 450. Since the gate voltage Vg from the first loop is applied to the gate of the NFET 450, the output voltage Vout is set by the first loop based on the reference voltage Vref. Assuming the gate-to-source voltage of the NFET 450 is approximately equal to the gate-to-source voltage of the transistor 420, the first loop sets the output voltage Vout to be approximately equal to the reference volage Vref. However, it is to be appreciated that the present disclosure is not limited to this example.

The source of the PFET 455 is coupled to the supply rail, the gate of the PFET 455 is coupled to the drain of the NFET 450, and the drain of the PFET 455 is coupled to the output 480 of the voltage regulator 405. The NFET 450 and the PFET 455 are coupled in a second loop that allows the current circuit 440 to handle large transient load currents (e.g., due to high-speed switching in the circuit 140), as discussed further below.

During operation, the output voltage Vout of the voltage regulator 405 is set by the first loop based on the reference voltage Vref. When a large transient load current is drawn by the circuit 140, the output voltage Vout at the source of the transistor 420 drops. This causes the drain voltage of the NFET 450 to also drop, which decreases (i.e., pulls down) the gate voltage of the PFET 455 since the gate of the PFET 455 is coupled to the drain of the NFET 450. The decreased gate voltage of the PFET 455 increases the conductance of the PFET 455, which increases the current supplied by the PFET 455. Thus, the second loop causes the current supplied by the PFET 455 to the circuit 140 to quickly increases in response to the transient load current. Thus, the PFET 455 supplies large currents when needed in response to large transient load currents. This allows the quiescent current of the NFET 450 to be low for low power consumption.

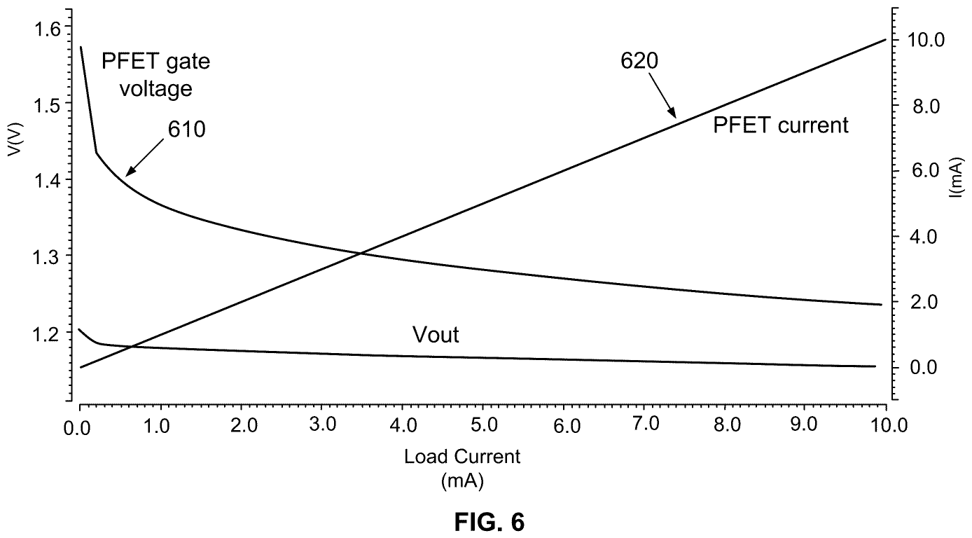

FIG. 6 is a plot showing an example of the gate voltage 610 of the PFET 455 and the current 620 of the PFET 455 versus load current. As shown in the example in FIG. 6, as the load current increases, the gate voltage 610 of the PFET is pulled down by the drain of the NFET 450, which increases the current 620 supplied by the PFET 455. In this example, the PFET 455 supplies most of the current of the voltage regulator 405 as the load current increases. The large current supplied by the PFET 455 significantly reduces the drop in the output voltage Vout of the voltage regulator 405 cause by large transient load currents. In the example in FIG. 6, the output voltage Vout of the voltage regulator drops from 1.2V to 1.155V as the load current increases to 10 mA.

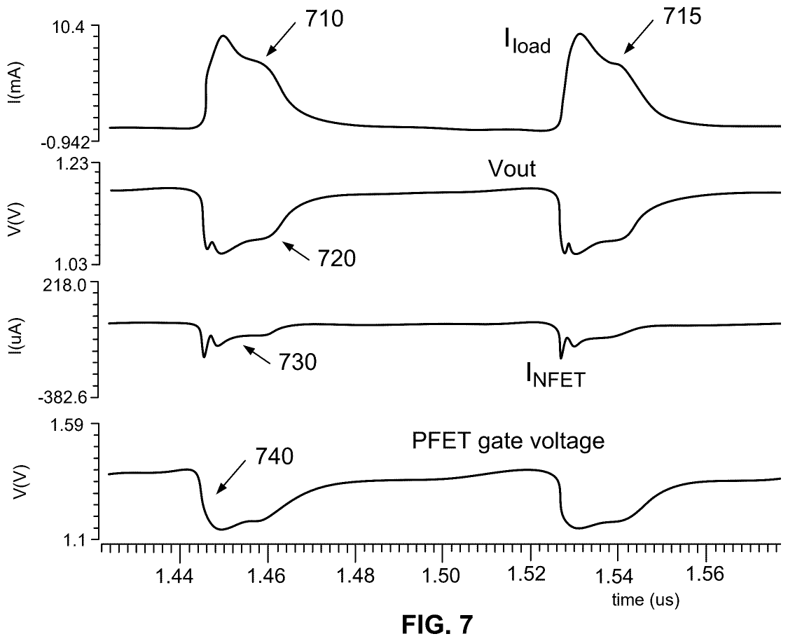

FIG. 7 is a timing diagram illustrating an example of transient load currents 710 and 715 at the output 480 of the voltage regulator 405 due to switching activity in the circuit 140. FIG. 7 also shows an example of the gate voltage 740 of the PFET 455, the current 730 of the NFET 450, and the output voltage 720 (i.e., Vout) of the voltage regulator 405. As shown in the example in FIG. 7, the transient load current 710 causes the output voltage 720 to drop. The NFET 450 quickly pulls down the gate voltage 740 of the PFET 455 in response to the drop in the output voltage 720. This significantly increases the current supplied to the circuit 140 by the PFET 455, which causes the output voltage 720 to rise back up. The PFET 455 supplies most of the current of the voltage regulator 405 in response to the transient load current 710.

In the example shown in FIG. 7, the quick response of the current circuit 440 allows the output voltage 720 to recover from the transient load current 710 before the next transient load current 715. Thus, the current circuit 440 provides good output voltage settling performance.

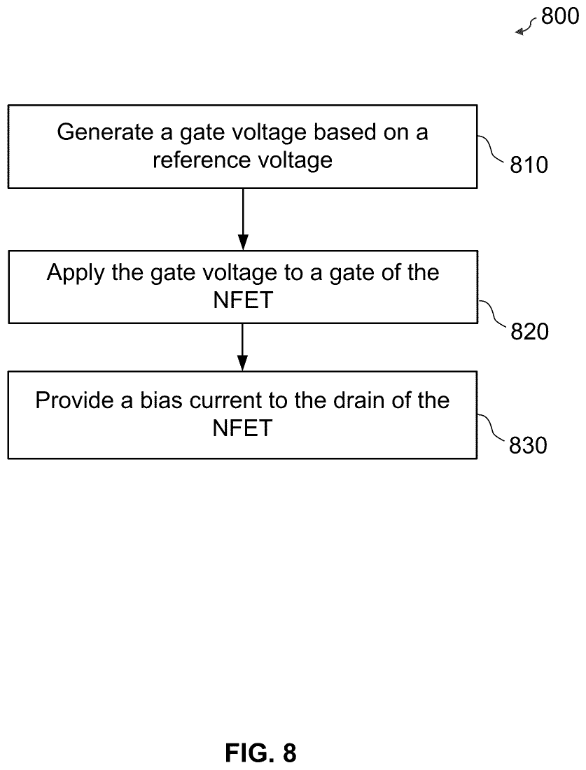

FIG. 8 shows an exemplary method 800 for operating a voltage regulator according to certain aspects. The voltage regulator (e.g., voltage regulator 405) includes an NFET (e.g., the NFET 450) and a PFET (e.g., PFET 455), wherein a source of the NFET is coupled to an output (e.g., output 480) of the voltage regulator, a source of the PFET is coupled to the supply rail, a gate of the PFET is coupled to a drain of the NFET, and a drain of the PFET is coupled to the output of the voltage regulator.

At block 810, a gate voltage is generated based on a reference voltage. For example, the gate voltage may be generated by the voltage circuit 410 and the reference voltage may correspond to the reference voltage Vref.

At block 820, the gate voltage is applied to a gate of the NFET.

At block 830, a bias current is provided to the drain of the NFET. For example, the bias current may be provided by the current source 460.

In certain aspects, the voltage regulator further includes a transistor (e.g., transistor 420) and generating the gate voltage based on the reference voltage includes applying the gate voltage to a gate of the transistor, sensing a voltage at a source of the transistor, and adjusting the gate voltage in a direction that reduces a difference between the voltage at the source of the transistor and the reference voltage. For example, the gate voltage may be adjusted by the amplifier 430. In this example, the amplifier 430 senses the voltage at the source of the transistor by coupling the source of the transistor to the second input 434 of the amplifier 430 via the feedback path 425.

In certain aspects, a drain of the transistor is coupled to the supply rail, and the voltage regulator further includes a first resistor (e.g., resistor 422) coupled between the source of the transistor and a low rail. In certain aspects, the voltage regulator further includes a second resistor (e.g., resistor 470) coupled between the source of the NFET and the low rail. In certain aspects, the transistor includes a second NFET.

Implementation examples are described in the following numbered clauses:
1. A voltage regulator, comprising:
   a voltage circuit configured to generate a gate voltage based on a reference voltage;
an n-type field effect transistor (NFET), wherein a gate of the NFET is coupled to the voltage circuit to receive the gate voltage, and a source of the NFET is coupled to an output of the voltage regulator;
a current source coupled between a supply rail and a drain of the NFET; and
a p-type field effect transistor (PFET), wherein a source of the PFET is coupled to the supply rail, a gate of the PFET is coupled to the drain of the NFET, and a drain of the PFET is coupled to the output of the voltage regulator.
2. The voltage regulator of clause 1, further comprising a resistor coupled between the source of the NFET and a low rail.
3. The voltage regulator of clause 1 or 2, wherein the voltage circuit comprises:
   a first resistor;
   a transistor coupled between the supply rail and the first resistor, wherein a gate of the transistor is coupled to the gate of the NFET; and
   an amplifier, wherein a first input of the amplifier is configured to receive the reference voltage, a second input of the amplifier is coupled between the transistor and the first resistor via a feedback path, and an output of the amplifier is coupled to the gate of the transistor.
4. The voltage regulator of clause 3, wherein the first resistor is coupled between the transistor and a low rail.
5. The voltage regulator of clause 4, further comprising a second resistor coupled between the source of the NFET and the low rail.
6. The voltage regulator of any one of clauses 3 to 5, wherein a drain of the transistor is coupled to the supply rail, and the second input of the amplifier is coupled to a source of the transistor via the feedback path.
7. The voltage regulator of clause 6, wherein the first resistor is coupled between the source of the transistor and a low rail.
8. The voltage regulator of clause 7, further comprising a second resistor coupled between the source of the NFET and the low rail.
9. A voltage regulator, comprising:
   a first n-type field effect transistor (NFET), wherein a drain of the first NFET is coupled to a supply rail;
   a first resistor coupled between a source of the first NFET and a low rail;
   an amplifier, wherein a first input of the amplifier is configured to receive a reference voltage, a second input of the amplifier is coupled to the source of the first NFET via a feedback path, and an output of the amplifier is coupled to a gate of the first NFET;
   a second NFET, wherein a gate of the second NFET is coupled to the gate of the first NFET, and a source of the second NFET is coupled to an output of the voltage regulator;
   a current source coupled between the supply rail and a drain of the second NFET; and
   a p-type field effect transistor (PFET), wherein a source of the PFET is coupled to the supply rail, a gate of the PFET is coupled to the drain of the second NFET, and a drain of the PFET is coupled to the output of the voltage regulator.
10. The voltage regulator of clause 9, further comprising a second resistor coupled between the source of the second NFET and the low rail.
11. The voltage regulator of clause 9 or 10, wherein a channel width of the second NFET is larger than a channel width of the first NFET.
12. The voltage regulator of clause 11, wherein the channel width of the second NFET is at least twice as large as the channel width of the first NFET.
13. A method for operating a voltage regulator, the voltage regulator including an n-type field effect transistor (NFET) and a p-type field effect transistor (PFET), wherein a source of the NFET is coupled to an output of the voltage regulator, a source of the PFET is coupled to a supply rail, a gate of the PFET is coupled to a drain of the NFET, and a drain of the PFET is coupled to the output of the voltage regulator, the method comprising:
   generating a gate voltage based on a reference voltage;
   applying the gate voltage to a gate of the NFET; and
   providing a bias current to the drain of the NFET.
14. The method of clause 13, wherein the voltage regulator further comprises a transistor, and wherein generating the gate voltage based on the reference voltage comprises:
applying the gate voltage to a gate of the transistor;
sensing a voltage at a source of the transistor; and
adjusting the gate voltage in a direction that reduces a difference between the voltage at the source of the transistor and the reference voltage.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect electrical coupling between two structures. It is also to be appreciated that an output may include multiple parallel outputs, and that an input may include multiple parallel inputs. As used herein, “approximately” means between 90 percent to 110 percent of the stated value.

Any reference to an element herein using a designation such as “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A voltage regulator, comprising:
a voltage circuit configured to generate a gate voltage based on a reference voltage;
an n-type field effect transistor (NFET), wherein a gate of the NFET is coupled to the voltage circuit to receive the gate voltage, and a source of the NFET is coupled to an output of the voltage regulator;
a current source coupled between a supply rail and a drain of the NFET; and
a p-type field effect transistor (PFET), wherein a source of the PFET is coupled to the supply rail, a gate of the PFET is coupled to the drain of the NFET, and a drain of the PFET is coupled to the output of the voltage regulator.

2. The voltage regulator of claim 1, further comprising a resistor coupled between the source of the NFET and a low rail.

3. The voltage regulator of claim 1, wherein the voltage circuit comprises:
a first resistor;
a transistor coupled between the supply rail and the first resistor, wherein a gate of the transistor is coupled to the gate of the NFET; and
an amplifier, wherein a first input of the amplifier is configured to receive the reference voltage, a second input of the amplifier is coupled between the transistor and the first resistor via a feedback path, and an output of the amplifier is coupled to the gate of the transistor.

4. The voltage regulator of claim 3, wherein the first resistor is coupled between the transistor and a low rail.

5. The voltage regulator of claim 4, further comprising a second resistor coupled between the source of the NFET and the low rail.

6. The voltage regulator of claim 3, wherein a drain of the transistor is coupled to the supply rail, and the second input of the amplifier is coupled to a source of the transistor via the feedback path.

7. The voltage regulator of claim 6, wherein the first resistor is coupled between the source of the transistor and a low rail.

8. The voltage regulator of claim 7, further comprising a second resistor coupled between the source of the NFET and the low rail.

9. A voltage regulator, comprising:
a first n-type field effect transistor (NFET), wherein a drain of the first NFET is coupled to a supply rail;
a first resistor coupled between a source of the first NFET and a low rail;
an amplifier, wherein a first input of the amplifier is configured to receive a reference voltage, a second input of the amplifier is coupled to the source of the first NFET via a feedback path, and an output of the amplifier is coupled to a gate of the first NFET;
a second NFET, wherein a gate of the second NFET is coupled to the gate of the first NFET, and a source of the second NFET is coupled to an output of the voltage regulator;
a current source coupled between the supply rail and a drain of the second NFET; and
a p-type field effect transistor (PFET), wherein a source of the PFET is coupled to the supply rail, a gate of the PFET is coupled to the drain of the second NFET, and a drain of the PFET is coupled to the output of the voltage regulator.

10. The voltage regulator of claim 9, further comprising a second resistor coupled between the source of the second NFET and the low rail.

11. The voltage regulator of claim 9, wherein a channel width of the second NFET is larger than a channel width of the first NFET.

12. The voltage regulator of claim 11, wherein the channel width of the second NFET is at least twice as large as the channel width of the first NFET.

13. A method for operating a voltage regulator, the voltage regulator including an n-type field effect transistor (NFET) and a p-type field effect transistor (PFET), wherein a source of the NFET is coupled to an output of the voltage regulator, a source of the PFET is coupled to a supply rail, a gate of the PFET is coupled to a drain of the NFET, and a drain of the PFET is coupled to the output of the voltage regulator, the method comprising:
generating a gate voltage based on a reference voltage;
applying the gate voltage to a gate of the NFET; and
providing a bias current to the drain of the NFET.

14. The method of claim 13, wherein the voltage regulator further comprises a transistor, and wherein generating the gate voltage based on the reference voltage comprises:
applying the gate voltage to a gate of the transistor;
sensing a voltage at a source of the transistor; and
adjusting the gate voltage in a direction that reduces a difference between the voltage at the source of the transistor and the reference voltage.
